(19) United States
(12) Patent Application Publication
(10) Pub. No.: US 2011/0057389 A1
(43) Pub. Date: Mar. 10, 2011

(54) FINANCIAL BOARD GAME

(75) Inventor: Elizabeth Coit, Carmel, IN (US)

(73) Assignee: Indiana State University, Terre Haute, IN (US)

(21) Appl. No.: 12/237,804

(22) Filed: Sep. 25, 2008

Related U.S. Application Data
(60) Provisional application No. 60/976,146, filed on Sep. 28, 2007.

(51) Int. Cl. A63F 3/00; G09B 19/00

(52) U.S. Cl. 273/256; 434/107

(57) ABSTRACT

A financial board game for use with a targeted population subset, typically including at least one child, is disclosed. The board game includes a board indicating at least one path including a plurality of spaces, wherein each space represents a single playing piece step, wherein each space corresponds to at least one color of a plurality of colors, a plurality of cards, wherein each card specifies at least one financially related question, each of the plurality of cards corresponding to at least one color of the plurality of colors, a plurality of pieces, wherein each pieces represents a player or a plurality of players, each of the plurality of pieces corresponding to at least one color of the plurality of colors, each of the plurality of pieces corresponding to the color of the start position, and a dice or die to generate random criteria for advancing each of the plurality of pieces.

### CROSS REFERENCE RELATED APPLICATIONS

This application claims the benefit of U.S. Provisional Patent Application No. 60/976,146, filed Sep. 28, 2007, the disclosure of which is expressly incorporated by reference.

### TECHNICAL FIELD

Embodiments of the present invention relate to an interactive educational system and method for teaching resource management. More particularly, embodiments of the invention are directed to an interactive educational system and method for promoting financial literacy.

### BACKGROUND

Currently, in most school systems, children have the opportunity to study a basic academic curriculum that includes such subjects as English, mathematics, history, and science. However, despite an opportunity to master these traditional academic subjects, children often graduate from school without knowledge of how to handle everyday financial tasks and with limited financial literacy.

In America each year, thousands of adults file for bankruptcy. Helping children to master financial concepts at an early age would better equip them to handle financial responsibly upon reaching adulthood. Additionally, in order to be ready for the competitive business world upon graduation, children should be provided with an opportunity to have a deep understanding of personal financial literacy. Some of the skills involved in personal financial literacy include financial functions, such as budgeting, saving, spending, giving, investing, filing taxes, solving financial issues, using credit cards responsibly, and purchasing insurance.

Although some schools do provide a financial literacy curriculum, problems frequently exist with such curricula. For instance, the materials provided by school systems to teach financial literacy are dull and fail to provide visual stimulation. Furthermore, the materials available do not include hands-on activities and exercises or interactive or computer-based games and activities. Often, the materials provided are difficult to relate to real life experiences.

### SUMMARY

The present disclosure includes a financial board game for use by a target population subset, comprising a board indicating at least one path including a plurality of spaces, wherein each space represents a single playing piece step, wherein each space corresponds to at least one color of a plurality of colors, wherein the plurality of spaces include a start position, wherein the plurality of spaces includes an end position, a plurality of cards, wherein each card specifies at least one financially related question, each of the plurality of cards corresponding to at least one color of the plurality of colors, a plurality of pieces, wherein each piece represents a player or a plurality of players of the target population subset, each of the plurality of pieces corresponding to at least one color of the plurality of colors, each of the plurality of pieces corresponding to the color of the start position, and a dice or die to generate random criteria for advancing each of the plurality of pieces.

The present disclosure also includes a method of educating a targeted population subset using financial information, the method comprising the steps of: providing a financial board game to the targeted population subset, wherein the targeted population subset is divided into individual players or pluralities of players, requiring a first player or at least one of a first plurality of players to correctly answer a first financially related question, providing a first representative playing piece associated with the first player or at least one of the first plurality of players, based on the correct answer to the first financially related question, allowing the first player or at least one of the first plurality of players to generate a first random criteria by a first throw of die, advancing the first representative playing piece along a common path of the board game followed by advancing the first representative playing piece along a first appropriate path of the board game based on the first random criteria, causing the first representative playing piece to land on at least one space of the board game, requiring a second player or at least one of a second plurality of players to correctly answer a second financially related question, providing a second representative playing piece associated with the second player or at least one of the second plurality of players, based on the correct answer to the second financially related question, allowing the second player or at least one of the second plurality of players to generate a second random criteria by a second throw of die, advancing the second representative playing piece along the common path of the board game followed by advancing the second representative playing piece along a second appropriate path of the board game based on the second random criteria, and repeating the steps associated with each group of the individual players or the pluralities of players until at least one of the representative playing pieces reaches at least one end position of the board game.

### BRIEF DESCRIPTION OF THE DRAWINGS

The above-mentioned and other features of this invention, and the manner of attaining them, will become more apparent and the invention itself will be better understood by reference to the following description of embodiments of the invention taken in conjunction with the accompanying drawings, wherein:

FIG. 1 is a perspective view illustrating a board of a financial board game in accordance with an embodiment of the present disclosure;

FIG. 2 is a perspective view illustrating a plurality of cards and a plurality of playing pieces of the financial board game in accordance with an embodiment of the present disclosure; and

FIG. 3 is a block diagram illustrating a method of educating a targeted population subset with financial information in accordance with an embodiment of the present disclosure.

Corresponding reference characters indicate corresponding parts throughout the several views. Although the drawings represent embodiments of the present invention, the drawings are not necessarily to scale and certain features may be exaggerated in order to better illustrate and explain the present invention.

### DETAILED DESCRIPTION OF THE EXEMPLARY EMBODIMENTS

The embodiments disclosed below are not intended to be exhaustive or limit the invention to the precise forms disclosed in the following detailed description. Rather, the embodiments are chosen and described so that others skilled in the art may utilize their teachings.

A financial board game including game components for use with a board game is disclosed. The board game includes a board, a plurality of player pieces, a plurality of cards. The board game optionally includes die, instructions, and resource curriculum. The financial board game is configured for use with a target population subset including at least one child. The at least one child may be a student being taught the resource curriculum.

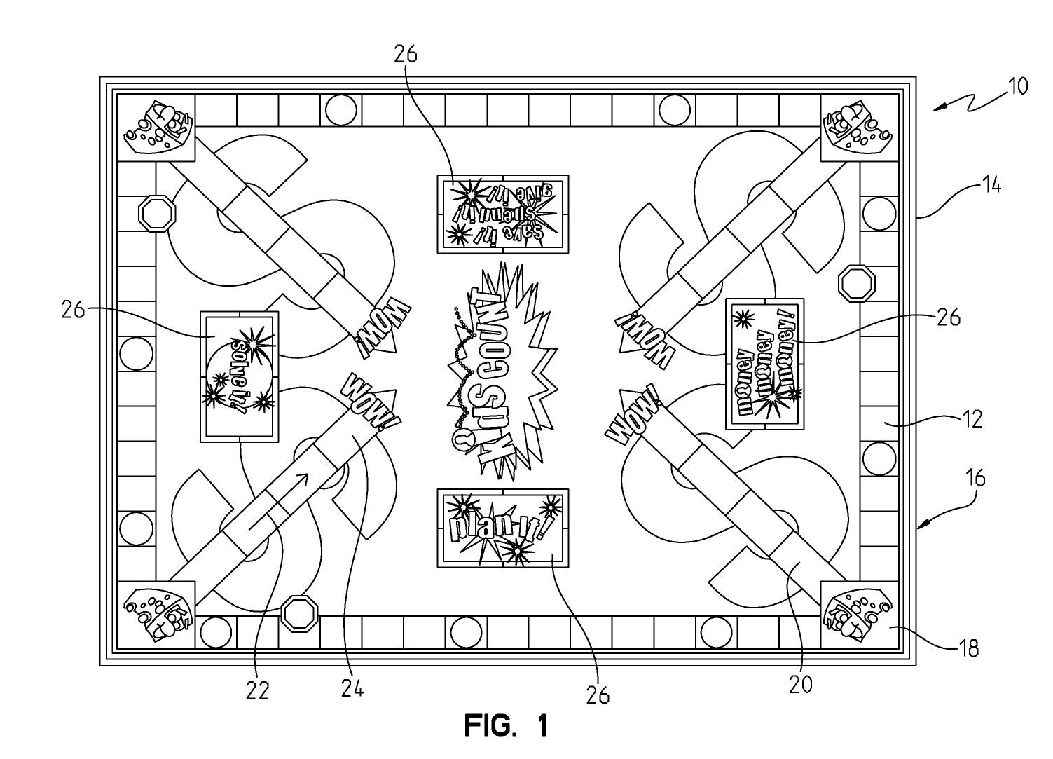

As it will be understood from knowledge of other board games and as fully described below, board 10 of a financial board game is illustrated in FIG. 1. As illustrated in FIG. 1, board 10 is rectangular. However, it is recognized that board 10 can be any shape or size. According to the present disclosure, board 10 indicates a plurality of spaces 12. As illustrated, some of the plurality of spaces 12 are indicated along perimeter 14 of board 10 with some spaces 12 disposed towards the middle, such as the center, of the board.

As illustrated, the majority of the spaces 12 are on perimeter 14 of board 10. In this illustrative embodiment, the majority of the spaces 12 on perimeter 14 of board 10 create common paths (i.e., either clockwise or counterclockwise around perimeter 14) for all players of the financial board game.

In this illustrative embodiment, several spaces 12 along perimeter 14 of board 10 show additional indications 16 and/or directions 16. In this illustrative embodiment, additional indications 16 are shown as “Give Money to a Kids Newspaper,” “Resist Impulse Spending,” “Credit Card Limit, Over Your Limit,” “Do Extra Chores,” “Tim's Car Wash, Create a Small Business Plan,” “Balance Your Checkbook,” “Lemonade 250, Open Lemonade Stand,” “Spend All Money on Wants,” “$, Open a Savings Account,” “Let's Go to the Movies, Plan for it in Your Budget,” “$, Thank You Grandma!,” “Free, Budget Food & Care for ‘Free’ Kitten,” and “Spend College Savings on Trading Cards.” In this illustrative embodiment, directions 16 are shown as “Go Ahead 1,” “Go Ahead 2,” “Go Ahead 3,” “Go Back 1,” “Go Back 2,” and “Go Back 3.”

In this illustrative embodiment, corners spaces 18 of board 10 are designated as spaces 12 along perimeter 14 of board 10. Corner spaces 18 may indicate start positions. In this illustrative embodiment, corner spaces 18 are also indicated as “Wild Spot.”

Additional spaces 20 are not along perimeter 14 of board 10. As shown in this illustrative embodiment, additional spaces 20 indicate paths 22 toward the center of board 10. In this illustrative embodiment there are four paths 22 indicated by four groups of additional spaces 20 toward the center and midpoint of board 10. In the illustrative embodiment, at least one of each of paths 22 indicate at least one space 20 as end position 24. In this illustrative embodiment, end positions 24 are indicated as “Wow You've Made It!”

In this illustrative embodiment, there are other designs on board 10. Some of the indicators and designs may relate to spaces 12, corner spaces 18, and paths 22. Designs are design oriented and may indicate trademarks such as “Kids Count,” “The Fun game of Dollars and Cents,” as well as trademarks for Indiana State University and Networks Financial Institute.

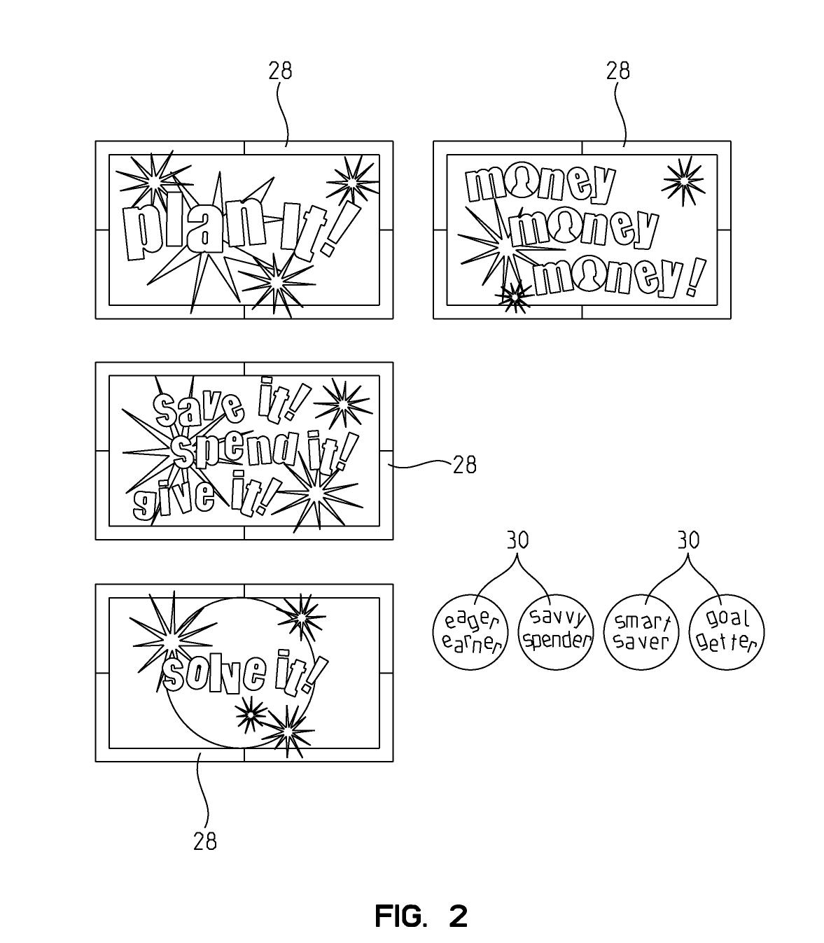

In this illustrative embodiment, indicators 26 on board 10 designate locations for pluralities of cards (FIG. 2) to be placed on board 10. Furthermore indicators 26 may correlate to match with at least one plurality of cards (FIG. 2). As illustrated, indicators 26 are shown as “Solve It!,” “Save It!, Spend It!, Give It!” “Money, Money, Money!,” and “Plan It!.” As discussed in greater detail below, indicators 26 may correlate to similar indications on at least one of the plurality of cards 28. Also indicators 26 may color coordinate to the at least one of the plurality of cards 28. As illustrated in FIG. 2, cards 28 are shown. As illustrated, cards 28 are shown to illustrate “Solve It!,” “Save It!, Spend It!, Give It!” “Money, Money, Money!,” and “Plan It!”.

Each player or group of players may associate with playing piece 30, as illustrated in FIG. 2. The objective of the financial board game is for each player or group of players to correctly answer financially related questions to advance their respective playing piece 30. Each player or group of players may advance their respective playing piece 30 along the common path followed by an appropriate path 22 leading toward end position 24. Respective playing piece 30 may advance the number of spaces corresponding to randomly generated criteria such as the throw of die. Based on the die, the respective playing piece lands on various spaces 12.

Each space 12 indicates an opportunity to answer a question provided on cards 28. As illustrated, the color of space 12 corresponds to the color of card 28. The plurality of playing cards 28 are indicated using similar indicators used for indicators 26 on board 10 such as “Solve It!,” “Save It!, Spend It!, Give It!” “Money, Money, Money!,” and “Plan It!.” In an exemplary embodiment, the pluralities of playing cards 28 are placed on board 10 during game play. Also the plurality of playing cards 28 may color coordinate to indicators 26 on board 10. The plurality of playing cards 28 may also color coordinate to the plurality of playing pieces 30.

The back side of each card 28 may indicate at least one financial literacy question. In one illustrative embodiment, the back side of card 28 includes a financially related question located, for example, beneath a heading such as illustrated heading “Question A”. The back side of each card 28 may also provide a second financially related question located, for example, beneath a heading such as illustrated Question B in a similar format as Question A. Question B may also be a financially related question of increased difficulty of Question A.

The at least one financial literacy question may correlate to headings on each of the plurality of playing cards 28. The at least one financial literacy question on each of the plurality of cards may relate to budgeting, saving, spending, giving, investing, filing taxes, solving financial issues, using credit cards responsibly, and purchasing insurance.

A moderator, administrator or question reader may decide to select either Question A or Question B throughout game play or on an individual basis. Furthermore, financially related questions relating to Question A or Question B may correspond to general financial literacy or information included within resource training materials such as a financial literacy booklet. Such resource training materials may include “Kids Count,” “The Road to Financial Literacy Teachers Handbook,” including any of the materials included therein. The resource training materials are expressly incorporated by reference. In an exemplary embodiment, the resource training materials are utilized as part of a resource curriculum. Financially related questions may also correspond to information provided by “My Family Counts” workbook or by any of the materials provided in relation to the “Money Bus” and other financial resources have been described in U.S. patent application Ser. No. 11/543,989, titled Interactive Resource Management Educational System and Method, filed Oct. 6, 2006, the subject matter of which is expressly incorporated by reference.

The financial board game may work as a supplemental resource component of a resource curriculum. Children may play the game in school or after having gone through the curriculum in school. Children would be able to use the financial board game as a way to reinforce the curriculum. Children may have to answer questions related to the curriculum and broader financial literary questions from outside the curriculum. Children may also hear the financially related question and answer as a way to supplement the curriculum. The financial board game may promote financial literacy for children of all ages, such as ages 8 years and up, such as third graders to fifth graders.

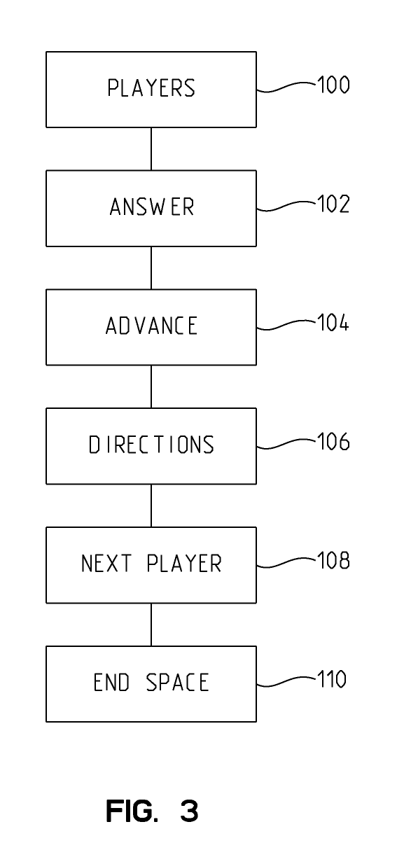

Referring to FIG. 3, a method of educating players about financial information is disclosed. In step 100, pluralities of players are formed. Players such as children may separate into up to four groups of players such as four individual players. In this illustrative embodiment, each player may associate to one playing piece 30. Each respective playing piece 30 may then be placed on any space 12 on board 10, such as the start positions also indicated as “Wild Spot”. Each playing piece 30 may relate to a start position based on color coordination.

Additional optional steps may occur, such as rolling the die to determine the order of player participation. Also optionally the players, moderator, or administrator can designate a question reader. Also optionally the pluralities of players may share the task of question reader.

In Step 102, a first participating player or plurality of players may be required to answer a financially-related question based on card 28 corresponding to the color of the participating player or plurality of players. The color of the participating player or plurality of players may correlate to the color of the “Wild Spot” space 12 on board 10. The color of the participating player or plurality of players may also correlate to the color of the participating players playing piece 30.

If the first participating player incorrectly answers the financially-related question, the correct answer may be provided by reference to general financial literacy or the corresponding resource curriculum. The moderator, administrator or question reader could also recite the correct answer providing an opportunity to educate a targeted population subset with financial information. The process of asking the question and providing the correct answer may reinforce the resource curriculum and therefore the learning process of educating a targeted population subset with financial information.

If the player or plurality of players answer correctly, as in Step 104, the player or plurality of players may generate random criteria, such as roll the die, and then advance their respective piece 30 a number of spaces 12 correlating to the random criteria. In a preferred embodiment, the players move their piece 30 in a clockwise fashion along the common path and then along one path 22 towards end position 24 of board 10. For example, in order to reach end position 24, the players move their piece 30 until the piece 30 completes a loop around the common path. Then their piece 30 may advance along one path 22 toward end position 24, indicated as the “Wow, You've Made It!” end position 24.

As illustrated in Step 106, the player follows any indications 26 including directions 26 on space 12 on which their respective piece 30 is located. Indications 26 or directions 26 may require playing piece 30 to advance or retreat or require the player or plurality of players to answer another financially related question. In Step 108, the second player or a second plurality of players repeats the steps of the first player such that the second player answers a financially related question before advancing their piece 30 to another space 12. Finally, as in Step 110, all players advance their respective pieces 30 until at least one piece 30 reaches end position 24.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A financial board game for use by a target population subset, comprising:
a board indicating at least one path including a plurality of spaces, wherein each space represents a single playing piece step, wherein each space corresponds to at least one color of a plurality of colors, wherein the plurality of spaces include a start position, wherein the plurality of spaces includes an end position,
a plurality of cards, wherein each card specifies at least one financially related question, each of the plurality of cards corresponding to at least one color of the plurality of colors,
a plurality of pieces, wherein each piece represents a player or a plurality of players of the target population subset, each of the plurality of pieces corresponding to at least one color of the plurality of colors, each of the plurality of pieces corresponding to the color of the start position, and
a dice or die to generate random criteria for advancing each of the plurality of pieces.

2. The financial board game of claim 1 wherein the at least one financially related question corresponds to information included within at least one resource training material.

3. The financial board game of claim 2 wherein the resource training material is a financial literacy booklet.

4. The financial board game of claim 2 wherein the resource training material includes information regarding budgeting, saving, spending, giving, investing, filing taxes, solving financial issues, using credit cards responsibly, or purchasing insurance.

5. The financial board game of claim 1, wherein the board displays a plurality of indicators, wherein each indicator corresponds to the at least one color of the plurality of colors.

6. The financial board game of claim 5, wherein the plurality of indicators and the plurality of cards each include headings selected from the group consisting of “Solve It!,” “Save It!, Spend It!, Give It!,” “Money, Money, Money!,” and “Plan It!.”

7. A method of educating a targeted population subset using financial information, the method comprising the steps of:
providing a financial board game to the targeted population subset, wherein the targeted population subset is divided into individual players or pluralities of players,
requiring a first player or at least one of a first plurality of players to correctly answer a first financially related question,
providing a first representative playing piece associated with the first player or at least one of the first plurality of players,
based on the correct answer to the first financially related question, allowing the first player or at least one of the first plurality of players to generate a first random criteria by a first throw of die,
advancing the first representative playing piece along a common path of the board game followed by advancing the first representative playing piece along a first appropriate path of the board game based on the first random criteria, causing the first representative playing piece to land on at least one space of the board game,
requiring a second player or at least one of a second plurality of players to correctly answer a second financially related question,
providing a second representative playing piece associated with the second player or at least one of the second plurality of players,
based on the correct answer to the second financially related question, allowing the second player or at least one of the second plurality of players to generate a second random criteria by a second throw of die,
advancing the second representative playing piece along the common path of the board game followed by advancing the second representative playing piece along a second appropriate path of the board game based on the second random criteria, and
repeating the steps associated with each group of the individual players or the pluralities of players until at least one of the representative playing pieces reaches at least one end position of the board game.

8. The method of claim 5, further comprising the step of:
repeating the steps associated with the first player or at least one of the first plurality of players followed by, repeating the steps associated with the second player or at least one of the second plurality of players until at least one of the representative playing pieces reaches at least one end position of the board game.

9. The method of claim 5, further comprising the steps of:
requiring a third player or at least one of a third plurality of players to correctly answer a third financially related question,
providing a third representative playing piece associated with the third player or at least one of the third plurality of players,
based on the correct answer to the second financially related question, allowing the third player or at least one of the third plurality of players to generate a third random criteria by a third throw of die,
advancing the third representative playing piece along the common path of the board game followed by advancing the third representative playing piece along a third appropriate path of the board game based on the third random criteria.

10. The method of claim 9, further comprising the step of:
repeating the steps associated with the first player or at least one of the first plurality of players followed by,
repeating the steps associated with the second player or at least one of the second plurality of players followed by,
repeating the steps associated with the third player or at least one of the third plurality of players until at least one of the first, the second, or the third representative playing pieces reaches at least one end position.

11. The method of claim 5, further comprising the steps of:
requiring a fourth player or at least one of a fourth plurality of players to correctly answer a fourth financially related question,
providing a fourth representative playing piece associated with the fourth player or at least one of the fourth plurality of players,
allowing the fourth player or at least one of the fourth plurality of players to generate a fourth random criteria by a fourth throw of die,
advancing the fourth representative playing piece along the common path of the board game followed by advancing the third representative playing piece along a fourth appropriate path of the board game based on the fourth random criteria.

12. The method of claim 11, further comprising the step of:
repeating the steps associated with the first player or at least one of the first plurality of players followed by,
repeating the steps associated with the second player or at least one of the second plurality of players followed by,
repeating the steps associated with the third player or at least one of the third plurality of players followed by,
repeating the steps associated with the fourth player or at least one of the fourth plurality of players until at least one of the first, the second, the third, or the fourth representative playing pieces reaches at least one end position.

13. The method of claim 5 wherein the financially related question is related to information provided by a resource training material.

14. The method of claim 5, further comprising the steps of:
requiring the first player or at least one of the first plurality of players to read any indicator associated with the at least one space.

15. The method of claim 14, wherein the indicator includes information regarding budgeting, saving, spending, giving, investing, filing taxes, solving financial issues, using credit cards responsibly, or purchasing insurance.

16. The method of claim 15, further comprising the step of:
requiring the first player or at least one of the first plurality of players to follow any direction associated with the at least one space.

17. The method of claim 16, wherein the first player or at least one of the first plurality of players derives a positive or negative interpretation of the indicator based on the direction.
